(19) United States
(12) Patent Application Publication
(10) Pub. No.: US 2004/0011184 A1
(43) Pub. Date: Jan. 22, 2004

(54) Wind chime tower

(76) Inventor: Jessie Ann Prall, Yakima, WA (US)

Correspondence Address: R. REAMS GOODLOE JR., SUITE 3, 10725 SE 256TH STREET, KENT, WA, 98030-8285, US

(21) Appl. No.: 10/340,403

(22) Filed: Jan. 10, 2003

Related U.S. Application Data
(60) Provisional application No. 60/347,724, filed on Jan. 11, 2002.

(51) Int. Cl. G10D 13/08

(52) U.S. Cl. 84/402

(57) ABSTRACT

A windchime support apparatus. The apparatus has a fan for providing a source of wind to a windchime suspended from the support apparatus. In one embodiment, an electrical fan with adjustable inlet damper is provided. An outlet screen is provided for the fan. The screen serves a base for supporting a plurality of airflow disrupting wooden balls. The airflow disrupter mechanism provided by the wooden balls serves to randomize the sounds generated by the windchime. An on-off electrical switch is provided.

### RELATED PATENT APPLICATIONS

This invention is related to U.S. Provisional Patent Application Serial No. 60/347,724, filed on Jan. 11, 2002, entitled Wind Chime Tower, the disclosure of which is incorporated herein in its entirety, including the specification, drawing, and claims, by this reference.

### COPYRIGHT RIGHTS IN THE DRAWING

A portion of the disclosure of this patent document contains material that is subject to copyright protection. The applicant no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates to the field of wind chimes. More particularly, the invention relates to apparatus for supporting wind chimes, and to apparatus and methods for operating wind chimes in the absence of natural wind.

### BACKGROUND

Chimes have been known for hundreds of years, and have long provided their pleasant sounds for people to enjoy. In various chime designs, chime elements produce a desired musical tone when struck, either by another chime or by a striker. Many different types of supports for wind chimes, and types of wind chime designs themselves, are in use today. Available support devices provide for juxtaposition of adjacent chimes, or of chimes and percussive striking instruments, to produce desired tones in response to movement in the wind of such chimes and/or adjacent percussive striking instruments. However, when the wind is still, such devices fall silent.

Some inventors have made attempts to remedy this situation, and various mechanical and magnetic schemes have been developed in an attempt to bring wind chimes to life in the absence of wind sources. Generally, though, such prior art devices have not resulted in providing a reasonable facsimile of sounds generated by natural wind sources.

Importantly, it would be a distinct and important improvement to provide a wind chime tower apparatus for practicing a method of generating sounds from wind chimes in the absence of an external wind source. Moreover, it would be desirable to provide a wind chime apparatus that can continuously produce pleasing sounds without being exposed to wind, and without the need for complicated mechanical percussive components. And, an improved method for operating a wind chime in the absence of an external wind source which in combination therewith also provides for pleasing random sound sequences would be especially desirable. Finally, the ability to provide an aesthetically pleasing wind chime tower structure for suspending wind chimes therefrom, while providing for activation of the suspended wind chimes in the absence of external wind sources, would be quite desirable. Thus, the important advantages of a product providing such desirable features in a workable wind chime tower apparatus can be readily appreciated.

### BRIEF DESCRIPTION OF THE DRAWING

In order to enable the reader to attain a more complete appreciation of the invention, and of the novel features and the advantages thereof, attention is directed to the following detailed description when considered in connection with the accompanying drawings, wherein:

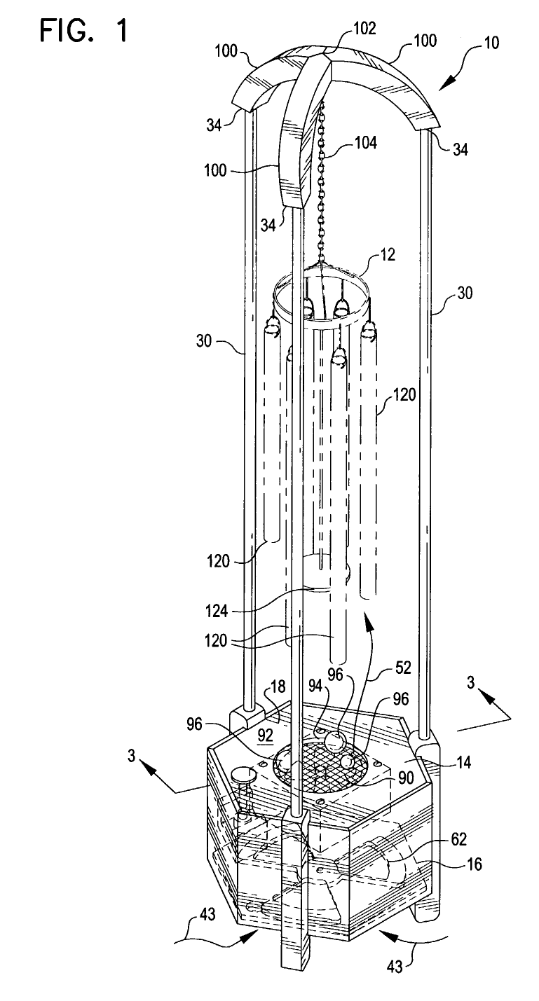

FIG. 1 is a perspective view of a wind chime tower, showing a base containing an electrically powered wind generating fan, an inlet damper for the fan, an outlet screen on the fan for protecting the fan and which provides a surface for supporting a plurality of airflow disrupting balls, base support legs which also serve to support tower pillars, connecting dome arch elements to connect the tower pillars, an adjustable hanger chain hanging from dome arch elements, and shown in phantom lines, a set of wind chimes having a chime ring, a plurality of chimes, and a striker.

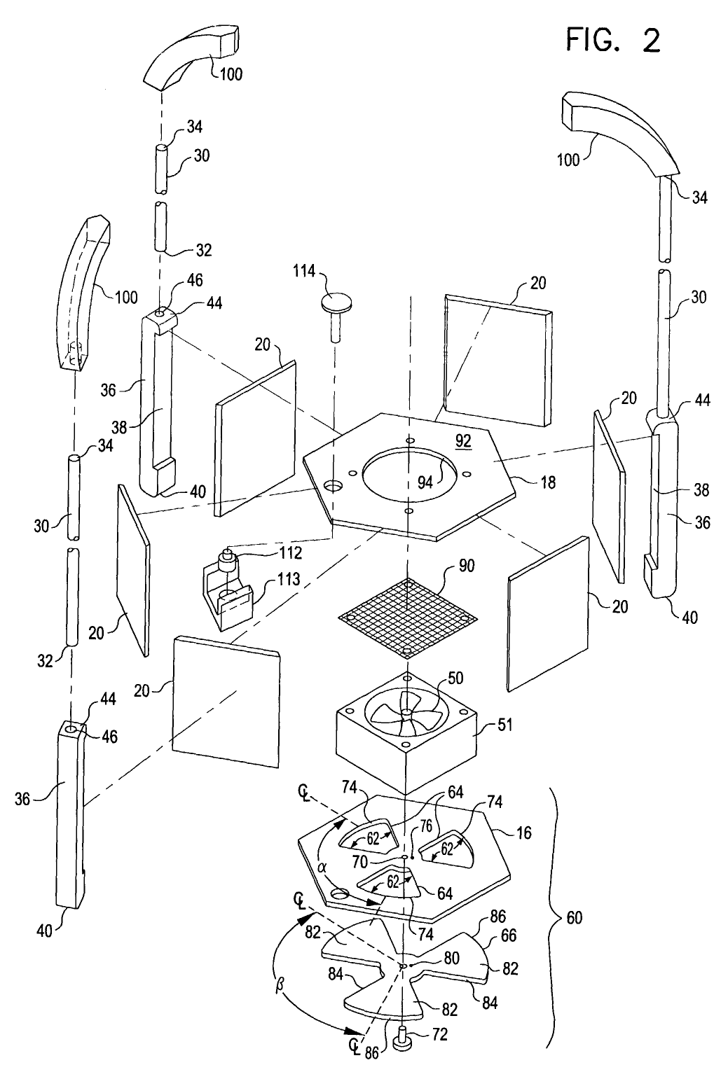

FIG. 2 is an exploded perspective view of various components of one embodiment of a wind chime tower, showing an inlet air damper structure, an inlet air fan, a base for supporting the damper structure and fan, an outlet screen, an outlet screen perimeter cover plate, base support legs, tower support pillars, and tower dome arch portions, as well as an on-off switch for an electrically driven fan.

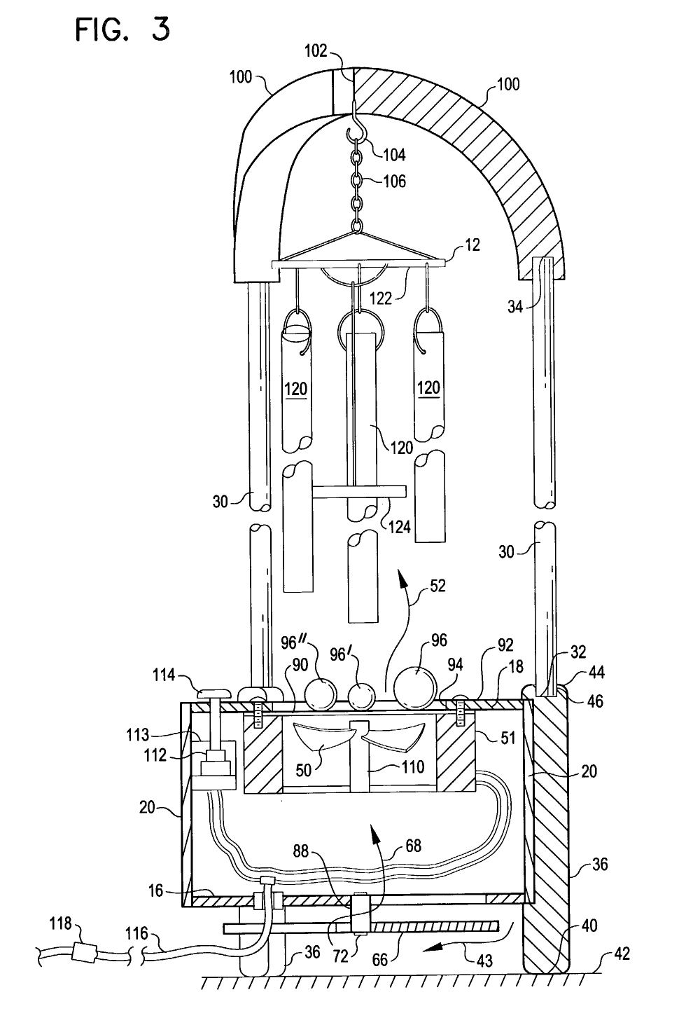

FIG. 3 is a vertical cross-sectional view, taken along line 3-3 of FIG. 1, now showing in detail the inlet air damper, an electrical fan with electrical power supply cable, and on-off switch, an outlet screen supporting a plurality of air flow disrupting balls, an outlet screen perimeter cover plate, and base support legs, tower support pillars, tower dome arch portions, and a hanger chain dangling from the tower dome to suspend therefrom a set of wind chimes having a striker.

The foregoing figures, being merely exemplary, contain various elements that may be present or omitted from actual implementations depending upon the circumstances. An attempt has been made to draw the figures in a way that illustrates at least those elements that are significant for an understanding of the various embodiments and aspects of the invention. However, various other elements of the wind chime tower, especially as applied for different variations of the functional components illustrated, embodiments, may be utilized in order to provide a robust, wind chime tower suitable for use in the absence of external wind sources.

### DETAILED DESCRIPTION

Turning now to FIG. 1, a perspective view of our novel switch windless windchime tower 10 is provided for supporting a windchime 12 (shown in hidden lines). The windchime tower 10 has a base 14 having a bottom 16 and a top 18. As further shown in FIG. 2, six planar sidewall panel portions 20 may be provided when base 14 provided in a hexagonal shape, however, other desired artistic shapes may be easily provided.

At least one pillar 30, and in the embodiment illustrated, three pillars 30 are provide. Each of pillars 30 have a first or lower end 32 and a second or upper end 34. As illustrated, base support legs 36, with a generally C-shaped cross section (in the radially inward direction) are sized and shaped to securely fit within the C-shaped recess portion 38 one of the sidewall panel portions 20, to support, via foot 40, the base 14 above a selected substrate 42 (see FIG. 3), so that airflow in the direction of reference arrows 43 can supply a fan, as further discussed below. At the upper end 44 of base support legs 36, a recess 46 is provided to accept and support the lower end 32 of a pillar 30.

A fan 50 with housing 51 is provided for discharge of air in the direction of reference arrows 52 toward the upper or second ends of the pillars 30 or, more specifically, toward windchime 12. The bottom 16 of base 14 is ideally configured to include an inlet damper 60. The inlet damper 60 has a first plate corresponding to bottom 16 of base 14. The first plate or bottom 16 has at least one opening 62 therethrough, and preferably three openings 62, each defined by sidewall edges 64, which are sized and shaped for allowing passage of air therethrough. A second at least partial plate 66 is situated for adjustably occluding at least some openings 62 though the first plate or bottom 16, so as adjustably vary the resistance to passage of inlet air in the direction of reference arrows 68 to the fan 50. In the embodiment shown in FIG. 2, the first plate or bottom 16 has a center 70, and the second plate 66 is pivotably affixed via pivot pin 72 to the first plate 16 at the center 70. A bushing 74 may be used to space second plate 66 from first plate 16. More specifically, the first plate has, as illustrated herein, three spaced apart generally triangular cutout portions 62 therethrough, with each of the cutout portions 62 each defined by edge wall portions 64 including an arcuate outer edge wall portion 74. As illustrated the cutout portions 62 are spaced outwardly from a center land 76 and located along centerlines spaced apart by an angle alpha (α) of about 120 degrees. As illustrated in this workable embodiment, the second plate 66 has a central hub portion 80 and three spaced apart generally triangular lobe portions 82. The triangular portions 82 are each defined by edge wall portions 84 including an arcuate outer edge wall portion 86. The triangular portions 82 are spaced outwardly from the central hub portion 80 and located along centerlines spaced angularly apart by an angle beta of (β) about 120 degrees apart. Note that the important feature is that the first or bottom plate 16 and the second plate 66 are sized and shaped in a complementary manner that the second plate 66 can be rotated relative to the first plate 16 to occlude at least some passage of air through one or more of the air flow passageway openings 62 in the first or bottom plate 16. As illustrated in FIG. 3, the second plate 66 can be spaced downward from the first plate 16 via bushing 88.

Above the fan 50, an outlet screen 90 is provided. The outlet screen 90 is perforated for passage of air from the fan 50 outward and upward through the screen 90. As illustrated, the top 18 of the base 14 also serves a dual purpose as an outlet screen perimeter cover plate. The outlet screen cover plate 18 has a top 92 and provides an opening defined by an interior edge wall 94 for outward passage of air from said fan therethrough. Also, the interior edge wall 94 serves as a containment wall for against lateral movement of air flow disrupters provided in the form of a plurality of balls 96. The balls 96 are disposed and supported on the outlet screen 90 and confined laterally by the interior edge wall 94 of the outlet screen cover plate 18. As illustrated in this embodiment, the airflow disrupter balls include balls 96, 96′, and 96″, each of different diameters. It has been found that wooden balls serve as excellent airflow disrupter balls, and in the embodiment illustrated, air flow disrupter balls having diameters of 1 inch, ¾ inch, and ½ inch diameter have been found workable.

As shown in the various figures, a plurality of tower dome arch portions 100 are utilized to extend upward and radially inward from upper end 34 of pillars 30 toward an arch center 102. A chain hook 104 is provided extending downwardly proximate the said arch center 102. The hook 104 is adapted for supporting a chime chain 106, for suspending a wind chime 12 therefrom.

As illustrated, the wind chime support apparatus 10 has a fan 50 with an electrically powered fan motor 110 electrical on-off switch 112 is provided mounted via bracket 113 in the base 14, with an upwardly extending actuator portion 114. Also, as illustrated, the fan 50 includes an alternating current electrical fan motor 110, and an electrical cord 116 and plug 118 adapted for supply of alternating current electrical energy to the fan 50.

As illustrated in FIG. 3, support apparatus 10 may additionally include a windchime 12. The windchime 12 may include a plurality of chimes 120 supported from a mounting ring 122 and a striker 124 for striking any one of the plurality of chimes 120. Thus, when wind driven by fan 50 moves striker 124 and/or chimes 120, the chimes 120 may be sounded. Note that a windchime 12 may include various resonating members for producing audible sounds. As illustrated, but not necessarily such resonating members are attached to a mounting ring 122 which is attached to the chain 106 and thence to hook 104, and hang freely therefrom. Due to the air flow variation caused by the air flow disrupters, namely, wooden balls vibrating in the fan produced wind, the striker 124 which is freely hanging can randomly swing and collide with the resonating chime members 120 when said striker is agitated by wind from the fan 50, to thereby cause the resonating chime members 120 to produce the audible sounds. As illustrated, but not necessarily, the resonating members 120 each are tubular cylindrical chime members.

The apparatus shown herein is only one possible configuration for practicing a method of providing a windless chime apparatus for operation in the absence of a natural wind source. Importantly, in practice of such method, a support apparatus is provided for supporting a windchime. The windchime may have one or more, and normally a plurality of resonating chimes. A wind generator, preferably in the form of an electrical fan, is provided. To randomize the sound generated, an airflow disrupting mechanism is provided. It has been found advantageous to utilize a plurality of air flow disrupter balls, in the form of wooden balls of differing diameter, for randomizing the produced wind chime sounds. This airflow disrupter mechanism provides for the adjustment of the sound intensity, and allows for the production of a natural non-repetitive chime sound to be provided by the combination of the windless chime tower 10 and the wind chime 12. This effect is also enhanced by adjustment of the amount of airflow allowed though the fan and thence to the chimes, by adjustment of the inlet air damper mechanism. When the push button “on-off” switch is activated, electricity powers the fan 50 to produce airflow. The airflow travels up through the fan outlet screen 90, or other outlet ports as may be devised within the general scope of this invention, and airflow disrupting balls 96, 96′, etc., or other devices for modifying the airflow are activated, allowing the chimes 12 to produce a natural windchime sound. Importantly, the frequency and intensity of the wind chime can be adjusted by closing the inlet damper to restrict airflow, or by changing the size and number of balls on the fan outlet screen 90, or by raising or lowering the wind chime on the hanging chain 104. These various adjustments allow a user to find the pleasing sound effect that they most prefer. And, although the wind chime tower depicted can be designed to hold or accept a standard wind chime in the general size ranges of (a) small, 6″ to 12″ chime length L, (b) medium, 12″ to 20″ chime length L, or (c) large, 20″ to 34″ chime length L, the actual size may be varied as necessary to suit any user preference.

It is to be appreciated that the various aspects and embodiments of a windless chime tower, and the methods of operating such windless chime devices as described herein are an important improvement in the state of the art. The novel windless chime tower is simple, robust, reliable, and susceptible to application in various configurations. Although only a few exemplary embodiments have been described in detail, various details are sufficiently set forth in the drawings and in the specification provided herein to enable one of ordinary skill in the art to make and use the invention(s), which need not be further described by additional writing in this detailed description.

Importantly, the aspects and embodiments described and claimed herein may be modified from those shown without materially departing from the novel teachings and advantages provided by this invention, and may be embodied in other specific forms without departing from the spirit or essential characteristics thereof. Therefore, the embodiments presented herein are to be considered in all respects as illustrative and not restrictive. As such, this disclosure is intended to cover the structures described herein and not only structural equivalents thereof, but also equivalent structures. Numerous modifications and variations are possible in light of the above teachings. It is therefore to be understood that within the scope of the appended claims, the invention(s) may be practiced otherwise than as specifically described herein. Thus, the scope of the invention(s), as set forth in the appended claims, and as indicated by the drawing and by the foregoing description, is intended to include variations from the embodiments provided which are nevertheless described by the broad interpretation and range properly afforded to the plain meaning of the claims set forth below.

1. An apparatus for supporting a windchime, comprising:
a base, said base having a bottom and a top;
at least one pillar, said pillar having a first end supported from said base and a second end extending above said base;
a fan for discharge of air toward said second end of said pillar;
proximate said second end of said pillar, a hanger for suspending a windchime.

2. The apparatus as set forth in claim 1, further comprising an airflow disrupter, said air flow disrupter providing at least some randomization in either quantity or velocity of air discharged from said fan.

3. The apparatus as set forth in claim 1, wherein said base comprises a case for said fan.

4. The apparatus as set forth in claim 2, wherein said base further comprises an inlet damper, said inlet damper comprising a first plate having at least one opening therethrough for allowing passage of air therethrough, and a second plate situated for adjustably occluding at least some past one opening, so as to vary the resistance to passage of inlet air to said fan.

5. The apparatus as set forth in claim 3, wherein said first plate has a center, and said second plate is pivotably affixed to said first plate at said center.

6. The apparatus as set forth in claim 5, wherein said first plate comprises three spaced apart generally triangular cutout portions therethrough, said cutout portions each defined by edge wall portions including an arcuate outer edge wall portion, said cutout portions spaced outwardly from a center land and located along centerlines about 120 degrees apart.

7. The apparatus as set forth in claim 5, wherein said second plate comprises comprises a central hub portion and three spaced apart generally triangular portions, said triangular portions each defined by edge wall portions including an arcuate outer edge wall portion, said triangular portions spaced outwardly from said central hub portion and located along centerlines about 120 degrees apart, said first plate and said second plate sized and shaped of complementary size in a manner that said second plate can be rotated relative to said first plate to occlude passage of air through one or more of said at least one openings.

8. The apparatus as set forth in claim 3, further comprising an outlet screen, said outlet screen perforated for passage of air from said fan out therethrough.

9. The apparatus as set forth in claim 8, further comprising an outlet screen perimeter cover plate, said outlet screen cover plate providing an opening defined by an interior edge wall for outward passage of air from said fan therethrough.

10. The apparatus as set forth in claim 9, wherein said air flow disrupter comprises a plurality of balls, said balls disposed and supported on said outlet screen and confined laterally by said interior edge wall of said outlet screen cover plate.

11. The apparatus as set forth in claim 10, wherein said plurality of balls comprises two balls of differing diameter.

12. The apparatus as set forth in claim 11, wherein said balls each comprise wooden spheres.

13. The apparatus as set forth in claim 1, further comprising a plurality of base support legs, said base support legs configured to space said bottom of said base above a selected substrate, so that said fan can accept inlet air through said bottom of said base.

14. The apparatus as set forth in claim 13, wherein a pillar extends upward from each one of said plurality of base support legs.

15. The apparatus as set forth in claim 14, further comprising a plurality of tower dome arch portions, said plurality of tower dome arch portions extending radially inwardly from an upper end of said pillar toward a arch center.

16. The apparatus as set forth in claim 15, wherein a chain hook is provided extending downwardly proximate said arch center, said hook adapted for suspending a wind chime therefrom.

17. The apparatus as set forth in claim 1, wherein said fan comprises an electrically powered fan motor, and wherein an on-off switch is provided in said base.

18. The apparatus as set forth in claim 17, further comprising (a) an alternating current electrical fan motor, and (b) an electrical cord and plug adapted for supply of alternating current electrical energy to said fan.

19. An apparatus for supporting a windchime, comprising:
a fan;
a base, said base containing said fan and having a bottom adapted to provide inlet air to said fan, and a top adapted for discharge of air from said fan, said base further comprising an inlet damper, said inlet damper comprising a first plate having at least one opening therethrough for allowing passage of air therethrough, and a second sectioned plate situated for adjustably occluding at least some of said at least one opening, so as to vary the resistance to passage of inlet air to said fan;
a plurality of base support legs supporting said base;
a pillar extending upwardly from each one of said plurality of base support legs, each one of said pillars having a first end supported from said base support leg and a second end extending above said first end;
a plurality of tower dome arch portions, each one of said plurality of tower dome arch portions extending radially inward from an upper end of said pillar toward a arch center;
a chain hook extending downwardly proximate said arch center, said hook adapted for suspending a wind chime therefrom;
said base further comprising an outlet screen, said outlet screen perforated for passage of air from said fan out therethrough;
said base further comprising an outlet screen perimeter cover plate, said outlet screen cover plate providing an opening defined by an interior edge wall for outward passage of air from said fan therethrough;
an air flow disrupter, said air flow disrupter comprising a plurality of balls, said balls disposed and supported on said outlet screen and confined laterally by said interior edge wall of said outlet screen cover plate.

20. The apparatus as set forth in claim 19, wherein said plurality of balls comprises two balls of differing diameter.

21. The apparatus as set forth in claim 20, wherein said balls each comprise wooden spheres.

22. The apparatus as set forth in claim 19, wherein said fan comprises an electrically powered fan motor, and wherein an on-off switch is provided in said base.

23. The apparatus as set forth in claim 22, further comprising (a) an alternating current electrical fan motor, and (b) an electrical cord and plug adapted for supply of alternating current electrical energy to said fan.

24. The apparatus as set forth in claim 19, further comprising a windchime, said windchime comprising a plurality of chimes supported from a supporting bracket and a striker for striking any one of said plurality of said chimes.

25. The apparatus as set forth in claim 24, said chimes are stricken by said striker upon being driven by wind from said fan.

26. The apparatus as set forth in claim 1, further comprising a plurality of resonating members for producing audible sounds, said members attached to a mounting ring attached to said chain hook and freely hanging therefrom; a striker for freely hanging therefrom to randomly swing and collide with said resonating members when said striker is agitated by wind from said fan, thereby causing said resonating members to produce the audible sounds.

27. The apparatus as set forth in claim 26, wherein the resonating members each comprise a tubular cylindrical chime members.

28. A method of operating wind chime in the absence of a natural wind source, comprising:
providing a support apparatus for supporting a windchime; said windchime having a plurality of resonating chimes;
providing a wind generating fan with said support apparatus;
providing an airflow disrupter to randomize the airflow provided from said fan toward said windchime;
running said fan to generate wind toward said windchime while said airflow disrupter is present in an airstream between said fan and said windchime.
